(19) United States
(12) Patent Application Publication
(10) Pub. No.: US 2026/0237340 A1
(43) Pub. Date: Aug. 13, 2026

(54) DIMMING METHOD OF DISPLAY DEVICE AND DISPLAY DEVICE

(71) Applicant: Xiamen Tianma Display Technology Co., Ltd., Xiamen (CN)

(72) Inventors: Qiaohong HUANG, Xiamen (CN); Ying SUN, Xiamen (CN); Qiang CHEN, Xiamen (CN); Qixin XU, Xiamen (CN); Guanzheng GUO, Xiamen (CN); Cheng WANG, Xiamen (CN); Wenlan LIU, Xiamen (CN)

(21) Appl. No.: 19/208,936

(22) Filed: May 15, 2025

(30) Foreign Application Priority Data
Feb. 7, 2025 (CN) 202510137189.7

(51) Int. Cl. G09G 3/20; G09G 3/3233

(52) U.S. Cl. CPC G09G 3/2096; G09G 3/3233; G09G 2310/06; G09G 2310/08; G09G 2320/0233; G09G 2320/0242; G09G 2320/0247; G09G 2320/0646; G09G 2320/0653; G09G 2320/0673; G09G 2330/023; G09G 2360/16

(57) ABSTRACT

A dimming method of a display device and a display device are provided. The dimming method includes: obtaining a target brightness of the display device; when the target brightness is less than a first preset dimming brightness threshold, setting a dimming mode of the display device to a PWM dimming mode; and, when the target brightness is larger than a second preset dimming brightness threshold, setting the dimming mode of the display device to a DC dimming mode. The first preset dimming brightness threshold is less than the second preset dimming brightness threshold. When the target brightness is less than or equal to the second preset dimming brightness threshold and the target brightness is larger than or equal to the first preset dimming brightness threshold, the dimming mode of the display device is set to a transition dimming mode.

### CROSS-REFERENCE TO RELATED APPLICATION

This application claims the priority of Chinese Patent Application No. 202510137189.7, filed on Feb. 7, 2025, the content of which is incorporated herein by reference in its entirety.

### TECHNICAL FIELD

The present disclosure generally relates to the field of display technology and, more particularly, relates to a dimming method of a display device and a display device.

### BACKGROUND

With the rapid development of display technology, users have higher and higher requirements for display effects of display devices. To evaluate the display effect of a display device, one of the requirements is to evaluate whether the brightness transition is smooth during a brightness adjustment process.

At present, OLED (Organic Light-Emitting Diode) screens have become a basic configuration of mid-to-high-end smartphones because of their advantages such as high flexibility, power saving, thin thickness, wide color gamut, and high contrast. For the adjustment of the brightness of an OLED screen, the transition effect of the brightness change during the brightness adjustment process is often poor, that is, the brightness mutation is prone to occur during the dimming process. And because the human eye has different adaptability to the brightness of the display device under different ambient brightness, the brightness mutation often causes the problem of poor visual effect when the user watches.

Therefore, it is a technical problem that needs to be solved urgently to provide a dimming method and a display device that are able to effectively improve the problem of brightness mutation during the dimming process, avoid instantaneous brightness mutation, and improve the display visual effect and display effect.

### SUMMARY

One aspect of the present disclosure provides a dimming method of a display device. The method includes: obtaining a target brightness of the display device; when the target brightness is less than a first preset dimming brightness threshold, setting a dimming mode of the display device to a PWM dimming mode; and when the target brightness is larger than a second preset dimming brightness threshold, setting the dimming mode of the display device to a DC dimming mode. The first preset dimming brightness threshold is less than the second preset dimming brightness threshold. The display device includes a light-emitting control circuit and a light-emitting module. The light-emitting control circuit is electrically connected to the light-emitting module, and is used to provide a light-emitting control signal to the light-emitting module. The display device further has a transition dimming mode. When the target brightness is less than or equal to the second preset dimming brightness threshold and the target brightness is larger than or equal to the first preset dimming brightness threshold, the dimming mode of the display device is set to the transition dimming mode. The transition dimming mode is executed between the PWM dimming mode and the DC dimming mode. In the PWM dimming mode, a number of pulses of the light-emitting control signal controlled by the light-emitting control circuit in one frame of display screens is N1. In the DC dimming mode, the number of pulses of the light-emitting control signal controlled by the light-emitting control circuit in one frame of display screens is N2. In the transition dimming mode, the number of pulses of the light-emitting control signal controlled by the light-emitting control circuit in one frame of display screens is N3, wherein N1, N2, and N3 are all positive integers, and N2<N3<N1.

Another aspect of the present disclosure provides a display device. The display device includes a light-emitting control circuit and a light-emitting module. The light-emitting control circuit is electrically connected to the light-emitting module. The light-emitting control circuit is used to provide a light-emitting control signal to the light-emitting module. When a target brightness is less than a first preset dimming brightness threshold, a dimming mode of the display device is set to a PWM dimming mode. When the target brightness is larger than a second preset dimming brightness threshold, the dimming mode of the display device is set to a DC dimming mode. The first preset dimming brightness threshold is less than the second preset dimming brightness threshold. The display device further has a transition dimming mode. When the target brightness is less than or equal to the second preset dimming brightness threshold and the target brightness is larger than or equal to the first preset dimming brightness threshold, the dimming mode of the display device is set to the transition dimming mode. The transition dimming mode is executed between the PWM dimming mode and the DC dimming mode. In the PWM dimming mode, a number of pulses of the light-emitting control signal controlled by the light-emitting control circuit in one frame of display screens is N1. In the DC dimming mode, the number of pulses of the light-emitting control signal controlled by the light-emitting control circuit in one frame of display screens is N2. In the transition dimming mode, the number of pulses of the light-emitting control signal controlled by the light-emitting control circuit in one frame of display screens is N3, wherein N1, N2, and N3 are all positive integers, and N2<N3<N1.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of a dimming method consistent with various disclosed embodiments in the present disclosure.

FIG. 2 illustrates a display device adopting a dimming method in FIG. 1 consistent with various disclosed embodiments in the present disclosure.

FIG. 3 illustrates a timing diagram of a light-emitting control circuit controlling a light-emitting control signal in one frame of displayed images with different dimming modes in a dimming method consistent with various disclosed embodiments in the present disclosure.

FIG. 4 illustrates another timing diagram of a light-emitting control circuit controlling a light-emitting control signal in one frame of displayed images with different dimming modes in a dimming method consistent with various disclosed embodiments in the present disclosure.

FIG. 5 illustrates another timing diagram of a light-emitting control circuit controlling a light-emitting control signal in one frame of displayed images with different dimming modes in a dimming method consistent with various disclosed embodiments in the present disclosure.

FIG. 6 illustrates another timing diagram of a light-emitting control circuit controlling a light-emitting control signal in one frame of displayed images with different dimming modes in a dimming method consistent with various disclosed embodiments in the present disclosure.

FIG. 7 illustrates another timing diagram of a light-emitting control circuit controlling a light-emitting control signal in one frame of displayed images with different dimming modes in a dimming method consistent with various disclosed embodiments in the present disclosure.

FIG. 8 illustrates a flow chart of another dimming method consistent with various disclosed embodiments in the present disclosure.

FIG. 9 is a diagram showing a corresponding setting relationship between a display brightness value and the number of pulses of a light-emitting control signal in a transition dimming mode of the display device provided by the embodiment of the present disclosure.

FIG. 10 illustrates a flow chart of another dimming method consistent with various disclosed embodiments in the present disclosure.

FIG. 11 illustrates a diagram showing another corresponding setting relationship between a display brightness value and the number of pulses of a light-emitting control signal in a transition dimming mode of the display device provided by the embodiment of the present disclosure.

FIG. 12 illustrates a schematic diagram of an electrical connection structure of pixel circuits and light-emitting elements consistent with various disclosed embodiments in the present disclosure.

FIG. 13 illustrates a structure of another exemplary display device adopting a dimming method in FIG. 1 consistent with various disclosed embodiments in the present disclosure.

FIG. 14 illustrates another timing diagram of a light-emitting control circuit controlling a light-emitting control signal in one frame of displayed images with different dimming modes in a dimming method consistent with various disclosed embodiments in the present disclosure.

FIG. 15 illustrates a linear relationship diagram between the display brightness value and the number of pulses of a light-emitting control signal provided by the embodiment of the present disclosure.

FIG. 16 illustrates another timing diagram of a light-emitting control circuit controlling a light-emitting control signal in one frame of displayed images with different dimming modes in a dimming method consistent with various disclosed embodiments in the present disclosure.

FIG. 17 illustrates another linear relationship diagram between display brightness value and number of pulses of a light-emitting control signal provided according to various embodiment of the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. In the drawings, the shape and size may be exaggerated, distorted, or simplified for clarity. Wherever possible, the same reference numbers will be used throughout the drawings to refer to the same or like parts, and a detailed description thereof may be omitted. Further, in the present disclosure, the disclosed embodiments and the features of the disclosed embodiments may be combined under conditions without conflicts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Moreover, the present disclosure is described with reference to schematic diagrams. For the convenience of descriptions of the embodiments, the cross-sectional views illustrating the device structures may not follow the common proportion and may be partially exaggerated. Besides, those schematic diagrams are merely examples, and not intended to limit the scope of the disclosure. Furthermore, a three-dimensional (3D) size including length, width, and depth should be considered during practical fabrication.

In the present disclosure, terms such as “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc., indicate orientations or positional relationships based on the orientations or positional relationships shown in the accompanying drawings, and are only for the convenience of describing the present disclosure and simplifying the description, and do not indicate or imply that the device or element referred to must have a specific orientation, be constructed and operated in a specific orientation, and therefore should not be understood as limiting the present disclosure.

In the present disclosure, relational terms such as first and second are only used to distinguish one entity or operation from another entity or operation, and do not necessarily require or imply any such actual relationship between these entities or operations or order. Moreover, the terms “including”, “comprising” or any other variants thereof are intended to cover non-exclusive inclusion, such that a process, method, article, or device that includes a series of elements includes not only those elements, but also those that are not explicitly listed or also include elements inherent to this process, method, article or equipment. If there are no more restrictions, the elements defined by the sentence “including . . . ” do not exclude the existence of other same elements in the process, method, article, or equipment that includes the elements.

It should be understood that when describing the structure of a component, when a layer or region is referred to as being “on” or “above” another layer or another region, the layer or region may be directly on the other layer or region, or indirectly on the other layer or region, for example, layers/components between the layer or region and another layer or another region. And, for example, when the component is reversed, the layer or region may be “below” or “under” the other layer or region. In the present disclosure, the term “electrical connection” refers to that two components are directly electrically connected with each other, or the two components are electrically connected via one or more other components.

In the present disclosure, unless otherwise clearly specified and limited, the terms “installed”, “connected”, “fixed” and the like appear, should be understood in a broad sense. For example, it can be a fixed connection, a detachable connection, or an integrated connection; it can be a mechanical connection or an electrical connection; it can be a direct connection or an indirect connection through an intermediate medium, it can be the internal connection of two elements or the interaction relationship between two elements, unless otherwise clearly defined. For those skilled in the art, the specific meanings of the above terms in the present disclosure can be understood according to the specific circumstances.

In the present disclosure, when an element is referred to as being “fixed to” or “disposed on” another element, it may be directly on the other element or there may be an intermediate element. When an element is considered to be “connected to” another element, it may be directly connected to the other element or there may be an intermediate element at the same time. If present, the terms “vertical”, “horizontal”, “upper”, “lower”, “left”, “right” and similar expressions are for illustrative purposes only and are not intended to be the only embodiment.

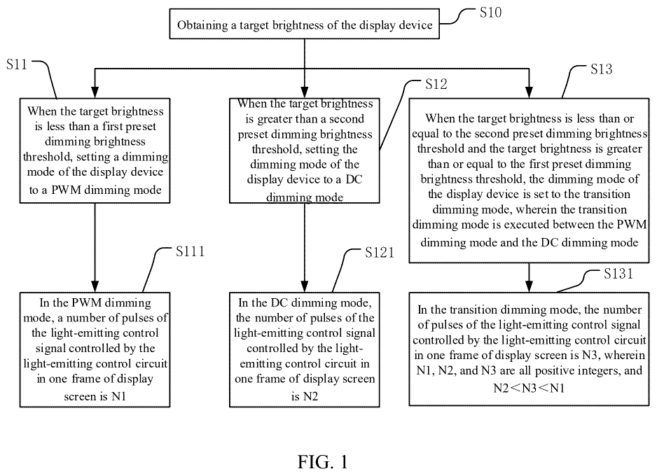

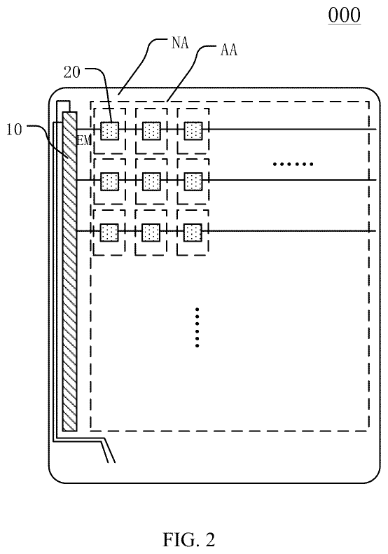

The present disclosure provides a dimming method of a display device. In one embodiment, as shown in FIG. 1 which is a flow chart of a dimming method of a display device and FIG. 2 which is a structural schematic diagram of a display device adopting the dimming method in FIG. 1, the dimming method may include:
S10, obtaining a target brightness of the display device;
S11, when the target brightness of the display device is less than a first preset dimming brightness threshold, setting a dimming mode of the display device to be a PWM dimming mode;
S12, when the target brightness of the display device is larger than a second preset dimming brightness threshold, setting the dimming mode of the display device to be a DC dimming mode, and
S13, when the target brightness of the display device is less than or equal to the second preset dimming brightness threshold and the target brightness is larger than or equal to the first preset dimming brightness threshold, setting the dimming mode of the display device to be a transition dimming mode

The transition dimming mode may be executed between the PWM dimming mode and the DC dimming mode. The first preset dimming brightness threshold may be less than the second preset dimming brightness threshold.

The display device 000 may include a light-emitting control circuit 10 and a light-emitting module 20. The light-emitting control circuit 10 and the light-emitting module 20 may be electrically connected, and the light-emitting control circuit 10 may be used to provide a light-emitting control signal EM for the light-emitting module 20.
S11 may include: S111, in the PWM dimming mode, the light-emitting control circuit controlling the number of pulses of the light-emitting control signal in a frame of the display screen to be N1.
S12 may include: S121, in the DC dimming mode, the light-emitting control circuit controlling the number of pulses of the light-emitting control signal in one frame of the display screen to be N2.
S13 may include: S131, in the transition dimming mode, the light-emitting control circuit controlling the number of pulses of the light-emitting control signal in one frame of the display screen to be N3.

N1, N2, and N3 may all be positive integers, and N2<N3<N1.

The dimming method of the display device provided in the present embodiment may be used to adjust the brightness of an organic light-emitting diode display device as much as possible. The dimming modes of the display device may include the PWM dimming mode and the DC dimming mode. The PWM dimming mode may refer to the use of a pulse width modulation (PWM) dimming method to adjust the brightness of the display device, and the DC dimming mode may refer to the use of a direct current (DC) dimming method to adjust the brightness of the display device. In existing technologies, for OLED display devices, the brightness is often adjusted by the PWM dimming mode at low brightness, and the brightness is adjusted by the DC dimming mode at high brightness. In the dimming method of the present embodiment, the target brightness of the display device may be first obtained. When the target brightness is less than the first preset dimming brightness threshold, the dimming mode of the display device may be set to be the PWM dimming mode, and when the target brightness is larger than the second preset dimming brightness threshold, the dimming mode of the display device may be set to be the DC dimming mode.

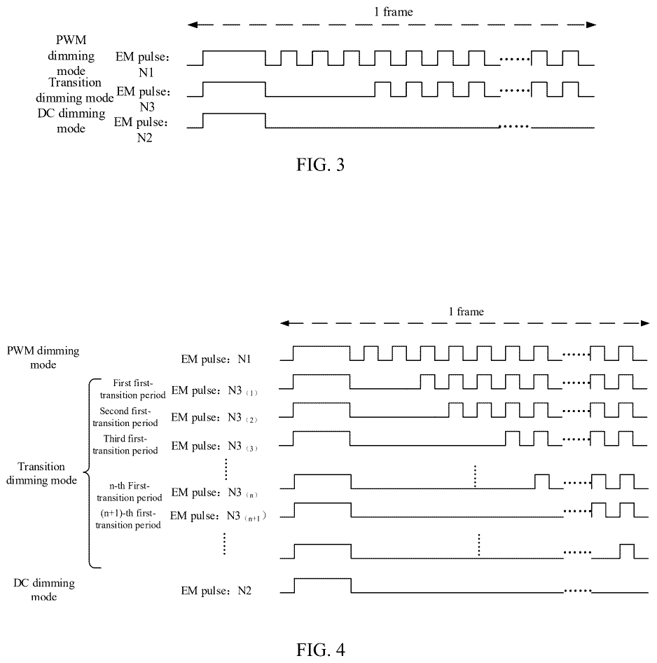

When using a low-frequency PWM dimming mode, users with sensitive eyes may clearly feel the flicker, that is, the phenomenon of alternating light and dark bars on the screen. First, it affects the viewing experience, and second, it will increase the tension of the eye muscles. Even users with insensitive eyes cannot see the alternation of light and dark, there may be a certain risk of eye damage. And with the continuous pursuit of physical health by consumers, to reduce screen flicker and achieve eye protection effects, the PWM dimming mode may use a high-frequency PWM dimming mode. That is, in the dimming method of this embodiment, when the target brightness is less than the first preset dimming brightness threshold, the dimming mode of the display device may be set to be a high-frequency PWM dimming mode. In the PWM dimming mode of the display device 000, the number of pulses of the light-emitting control signal EM in one frame (1 frame) of the display screen may be N1, as shown in FIG. 3 which is a timing diagram of the light-emitting control circuit controlling the light-emitting control signal in one frame of the display screen under different dimming modes in the dimming method provided in the embodiment of the present disclosure. As shown in FIG. 2, the display device 000 may include a light-emitting control circuit 10 and a light-emitting module 20. The light-emitting control circuit 10 and the light-emitting module 20 may be electrically connected, and the light-emitting control circuit 10 may be used to provide the light-emitting control signal EM for the light-emitting module 20. Optionally, the light-emitting control circuit 10 may be located in a non-display area NA of the display device 000, and the light-emitting module 20 may be a partial module of the pixel circuit, located in a display area AA of the display device 000. The light-emitting control circuit 10 may provide a clock signal, VGH, VGL, or other signals to the light-emitting control circuit 10 through a display driving chip such as DDIC, such that the light-emitting control circuit 10 generates the light-emitting control signal EM to the control end of the light-emitting module 20 in the pixel circuit of the display area AA, to control the turn-on or turn-off of the light-emitting module 20 and then drive the light-emitting elements of the display area AA to emit light or not. The structure of the display device 000 is not described in detail in this embodiment, and the references may be made to the structures of existing display devices for understanding.

When the target brightness is larger than the second preset dimming brightness threshold, the dimming mode of the display device may be switched to the DC dimming mode. As shown in FIG. 3, in the DC dimming mode of the display device 000, the number of pulses of the light-emitting control signal EM controlled by the light-emitting control circuit 10 in one frame of the display screen may be N2. Optionally, N2 may generally be 1 or 2. For example, preferably N2 is 1, that is, the number of pulses of the light-emitting control signal EM controlled by the light-emitting control circuit 10 in one frame of the display screen may be 1 (1 pulse).

As the PWM frequency increases, the number of pulses of the light-emitting control signal EM in the PWM dimming mode may also increase, while the light-emitting control signal EM in the DC dimming mode is generally 1 pulse or 2 pulses, resulting in a high number of pulses of the light-emitting control signal EM in the PWM dimming mode while the pulse of the light-emitting control signal EM in the DC dimming mode does not change. Therefore, when the dimming mode of the display device is switched from the PWM dimming mode to the DC dimming mode, the light-emitting control circuit 10 may control the light-emitting control signal EM in one frame of display screens to change from multi-pulse coupled light emission to single-pulse DC light emission, and the difference in light-emitting current may cause an obvious brightness mutation. As the number of pulses of the light-emitting control signal EM increases, the brightness mutation may become more obvious.

The light-emitting control signal EM provided by the light-emitting control circuit 10 may be an electrical signal for controlling the light-emitting elements in the display device, such as an OLED device, to emit light. In one embodiment, the light-emitting module 20 may include a P-type transistor, one light-emitting element may emit light when the light-emitting control signal EM is pulled low. The light-emitting control signal EM of one frame of the display screen may have 1 to N pulses, corresponding to 1 to N EM pulses. The light-emitting current of the light-emitting element in the PWM dimming mode may be usually smaller than the light-emitting current of the light-emitting element in the DC dimming mode. Assuming that the light-emitting control signal EM provided by the light-emitting control circuit 10 before the PWM dimming mode is switched to the DC dimming mode has N1 EM pulses and the light-emitting control signal EM provided by the light-emitting control circuit 10 in the DC dimming mode has N2 EM pulses such as 1 EM pulse, when the number of EM pulses in the PWM dimming mode is more, that is, when the value of N1 is larger, the light-emitting time may be larger, the required light-emitting current of the light-emitting element may be smaller. Therefore, when the PWM dimming mode is switched to the DC dimming mode, the brightness mutation may occur more easily because of the larger current difference.

To solve the above problems, it may be set that the dimming modes of the display device in this embodiment further includes the transition dimming mode. The transition dimming mode may be executed between the PWM dimming mode and the DC dimming mode. When the target brightness is less than or equal to the second preset dimming brightness threshold, and the target brightness is larger than or equal to the first preset dimming brightness threshold, the dimming mode of the display device may be set to be the transition dimming mode. As shown in FIG. 3, in the transition dimming mode of the display device 000, the light-emitting control circuit 10 may control the number of pulses of the light-emitting control signal EM in one frame of the display screen to be N3, where N2<N3<N1. That is, in the transition dimming mode, the light-emitting control circuit 10 may control the number of pulses of the light-emitting control signal EM in one frame of the display screen to be between N1 and N2, such that the transition dimming mode is added for transition when the display device switches between the PWM dimming mode and the DC dimming mode. For example, before the dimming mode of the display device is switched from the PWM dimming mode to the DC dimming mode, the transition dimming mode may be first executed, and the light-emitting control circuit 10 may control the light-emitting control signal EM in one frame of the display screen to first transit from multi-pulse coupled light emission to the transition dimming mode in which the number of pulses of the light-emitting control signal EM is N3, and then to switch from the transition dimming mode in which the number of pulses of the light-emitting control signal EM is N3 to the DC dimming mode in which the number of pulses of the light-emitting control signal EM is N2. During the switching process between the PWM dimming mode and the DC dimming mode, the transition dimming mode may be added for the display device, and the pulse number N3 of the light-emitting control signal EM in the transition dimming mode may be between the pulse number N1 of the light-emitting control signal EM in the PWM dimming mode and the pulse number N2 of the light-emitting control signal EM in the DC dimming mode, which may avoid the brightness mutation caused by the difference in the light-emitting current, reduce the instantaneous brightness mutation in the dimming process, effectively improve the visual effect, and ensure the display effect of the display device.

In existing technologies, to improve the problem of brightness mutation during the dimming process of the display device, there are methods to improve the brightness mutation by adjusting the duty cycle of the light-emitting control signal, such as adjusting the duty cycle transition of the light-emitting control signal. Also, increasing the width of the porch area (the porch area is a virtual space when the screen is driven, which does not exist physically but participates in the normal driving of the screen) is used to narrow the brightness gap between the PWM dimming mode and the DC dimming mode, and reduce the brightness mutation. However, under the premise that the screen refresh frequency is fixed, the increase in the number of porch area rows will lead to a reduction in the charging time of each row of pixels, which will greatly reduce the effective time of a row of pixels, affect the charging time, and then affect the display quality. The brightness mutation may be improved by adjusting the duty cycle transition of the light-emitting control signal, but the adjustment method is relatively complicated. As the number of pulses of the light-emitting control signal EM increases, adjusting the duty cycle transition of the light-emitting control signal EM to the limit cannot improve the flicker problem caused by the brightness mutation during switching.

In the dimming modes of the display device provided in the present embodiment, the transition dimming mode may be added and executed between the PWM dimming mode and the DC dimming mode. When the target brightness is less than the first preset dimming brightness threshold, the dimming mode of the display device may be set to be the PWM dimming mode, the display device 000 may be in the PWM dimming mode, and the number of pulses of the light-emitting control signal EM in one frame of the display screen controlled by the light-emitting control circuit 10 may be N1. When the target brightness is less than or equal to the second preset dimming brightness threshold and the target brightness is larger than or equal to the first preset dimming brightness threshold, the dimming mode of the display device may be set to be the transition dimming mode, the display device 000 may be in the transition dimming mode, and the number of pulses of the light-emitting control signal EM in one frame of the display screen controlled by the light-emitting control circuit 10 may be N3. When the target brightness is larger than the second preset dimming brightness threshold, the dimming mode of the display device may be set to be the DC dimming mode, the display device 000 may be in the DC dimming mode, and the number of pulses of the light-emitting control signal EM in one frame of the display screen controlled by the light-emitting control circuit 10 may be N2, where N2<N3<N1. In the transition dimming mode, the light-emitting control circuit 10 may control the number of pulses N3 of the light-emitting control signal EM in one frame of display screens to transit between N1 and N2. By directly adjusting the transition of the number of pulses of the light-emitting control signal EM in one frame of display screens, the number of pulses of the light-emitting control signal EM may be directly and flexibly set without being limited to the complicated adjustment of the duty cycle. This may avoid brightness mutations caused by differences in light-emitting current, reduce instantaneous brightness mutations in the dimming process, effectively improve visual effects, ensure the display effect of the display device, and at the same time help simplify the dimming steps, reduce the complexity of the dimming process, and improve the driving performance of the display device.

The number of pulses of the light-emitting control signal EM in one frame of display screen of the display device 000 in the PWM dimming mode, the DC dimming mode, and the transition dimming mode, in the embodiment shown in FIG. 3 is used as an example only to illustrate the present disclosure, and does not limit the scope of the present disclosure. In implementation, it is only necessary to satisfy N2<N3<N1 such that the display device 000 can transition through the transition dimming mode during the switching process between the DC dimming mode and the PWM dimming mode.

In some embodiments, in the transition dimming mode, the number of pulses of the light-emitting control signal EM in different frames of the display screen may be different or the same. For example, before the display device switches from the PWM dimming mode to the DC dimming mode, the number of pulses of the light-emitting control signal EM in different frames of the display screen in the transition dimming mode may be gradually reduced; or before the display device switches from the DC dimming mode to the PWM dimming mode, the number of pulses of the light-emitting control signal EM in different frames of the display screen in the transition dimming mode may be gradually increase. It is only necessary to satisfy that the number of pulses N3 of the light-emitting control signal EM in one frame of the display screen in the transition dimming mode is between N2 and N1.

In this embodiment, when the target brightness of the display device is less than the first preset dimming brightness threshold, the dimming mode of the display device may be set to be the PWM dimming mode. When the target brightness is larger than the second preset dimming brightness threshold, the dimming mode of the display device may be set to be the DC dimming mode. This embodiment does not limit the first preset dimming brightness threshold and the second preset dimming brightness threshold. It only needs to satisfy that the first preset dimming brightness threshold is less than the second preset dimming brightness threshold, such that the display device adopts the PWM dimming mode at low brightness and the DC dimming mode at high brightness.

In some optional embodiments, as shown in FIG. 1, FIG. 2, and FIG. 4 which is another timing diagram of the light-emitting control circuit controlling the light-emitting control signal in one frame of the display screen under different dimming modes in the dimming method, when the PWM dimming mode is switched to the DC dimming mode, the transition dimming mode may include multiple first-transition dimming periods.

During the n-th first-transition dimming period, the light-emitting control circuit 10 may control the number of pulses of the light-emitting control signal EM in one frame of the display screen to be N3₍ₙ₎; and
during the (n+1)-th first-transition dimming period, the light-emitting control circuit 10 may control the number of pulses of the light-emitting control signal EM in one frame of the display screen to be N3₍ₙ₊₁₎, where n is a positive integer.

The (n+1)-th first-transition dimming period may be executed after the n-th first-transition dimming period, and N3₍ₙ₊₁₎<N3₍ₙ₎.

Optionally, 1≤N3₍ₙ₎−N3₍ₙ₊₁₎≤3.

In this embodiment, when the dimming mode of the display device is switched from the PWM dimming mode at low brightness to the DC dimming mode at high brightness, the transition dimming mode may be added before the DC dimming mode is executed, and the transition dimming mode may include the plurality of first-transition dimming periods. The number of pulses of the light-emitting control signal EM in one frame of the display screen controlled by the light-emitting control circuit 10 in the PWM dimming mode is N1. In the plurality of first-transition dimming periods in the transition dimming mode, in the n-th first-transition dimming period, the number of pulses of the light-emitting control signal EM in one frame of the display screen controlled by the light-emitting control circuit 10 may be N3₍ₙ₎, and in the (n+1)-th first-transition dimming period, the number of pulses of the light-emitting control signal EM in one frame of the display screen controlled by the light-emitting control circuit 10 may be N3₍ₙ₊₁₎, where N3₍ₙ₊₁₎<N3₍ₙ₎. For example, in the plurality of first-transition dimming periods in the transition dimming mode, during the first-transition dimming period, the number of pulses of the light-emitting control signal EM controlled by the light-emitting control circuit 10 in one frame of the display screen may be N3₍₁₎, during the second first-transition dimming period, the number of pulses of the light-emitting control signal EM controlled by the light-emitting control circuit 10 in one frame of the display screen is N3₍₂₎, and during the third first-transition dimming period, the number of pulses of the light-emitting control signal EM controlled by the light-emitting control circuit 10 in one frame of the display screen may be N3₍₃₎, . . . , during the n-th first-transition dimming period, the number of pulses of the light-emitting control signal EM in one frame of the display screen controlled by the light-emitting control circuit 10 may be N3₍ₙ₎, and during the (n+1)-th first-transition dimming period, the number of pulses of the light-emitting control signal EM in one frame of the display screen controlled by the light-emitting control circuit 10 may be N3₍ₙ₊₁₎, where N3₍₁₎>N3₍₂₎>N3₍₃₎> . . . >N3₍ₙ₎>N3₍ₙ₊₁₎ . . . .

In this embodiment, before the display device switches from the PWM dimming mode to the DC dimming mode, during the plurality of first-transition dimming periods, the number of pulses of the light-emitting control signal EM may gradually decrease, and 1≤N3₍ₙ₎−N3₍ₙ₊₁₎≤3. During two adjacent first-transition dimming periods, the number of pulses of the light-emitting control signal EM in the latter first-transition dimming period may be 1-3 pulses less than the number of pulses of the light-emitting control signal EM in the former first-transition dimming period, to gradually transition to the DC dimming mode, thereby avoiding sudden brightness changes caused by differences in the light-emitting current, reducing instantaneous sudden brightness changes in the dimming process, effectively improving the visual effect, and ensuring the display effect of the display device.

Further optionally, in one embodiment, as shown in FIG. 1, FIG. 2 and FIG. 5 which is another timing diagram of the light-emitting control circuit controlling the light-emitting control signal in one frame of the display screen under different dimming modes, during the (n−1)-th first-transition dimming period, the light-emitting control circuit 10 may control the number of pulses of the light-emitting control signal EM in one frame of the display screen to be N3₍ₙ₋₁₎; where N3₍ₙ₎−N3₍ₙ₊₁₎=N3₍ₙ₋₁₎−N3₍ₙ₎.

In the present embodiment, before the display device switches from the PWM dimming mode to the DC dimming mode, during the plurality of first-transition dimming periods in the transition dimming mode, the number of pulses of the light-emitting control signal EM may gradually decrease, and 1≤N3₍ₙ₎−N3₍ₙ₊₁₎=N3₍ₙ₋₁₎−N3₍ₙ₎≤3. During two adjacent first-transition dimming periods, the number of pulses of the light-emitting control signal EM during the latter first-transition dimming period may be 1-3 pulses less than the number of pulses of the light-emitting control signal EM during the former first-transition dimming period, and the number of pulses reduced by the light-emitting control signal EM during the two adjacent first-transition dimming periods may be the same, for example, as shown in FIG. 5, that is, N3₍ₙ₎−N3₍ₙ₊₁₎=N3₍ₙ₋₁₎−N3₍ₙ₎=1. By uniformly adjusting the transition of the number of pulses of the light-emitting control signal EM, the transition to the DC dimming mode may be performed in a step-by-step manner, which may avoid brightness mutations caused by differences in light-emitting current, reduce instantaneous brightness mutations during the dimming process, effectively improve visual effects, ensure the display effect of the display device, and improve the uniformity of display brightness.

It can be understood that FIG. 5 of the present embodiment is only an example to illustrate the number of pulses of the light-emitting control signal EM during the plurality of first-transition dimming periods in the transition dimming mode. In specific implementations, the number of pulses reduced in the light-emitting control signal EM during two adjacent first-transition dimming periods may be the same, and may be reduced by 2 pulses or 3 pulses. It is only necessary to satisfy that the number of pulses reduced in the light-emitting control signal EM during two adjacent first-transition dimming periods is the same.

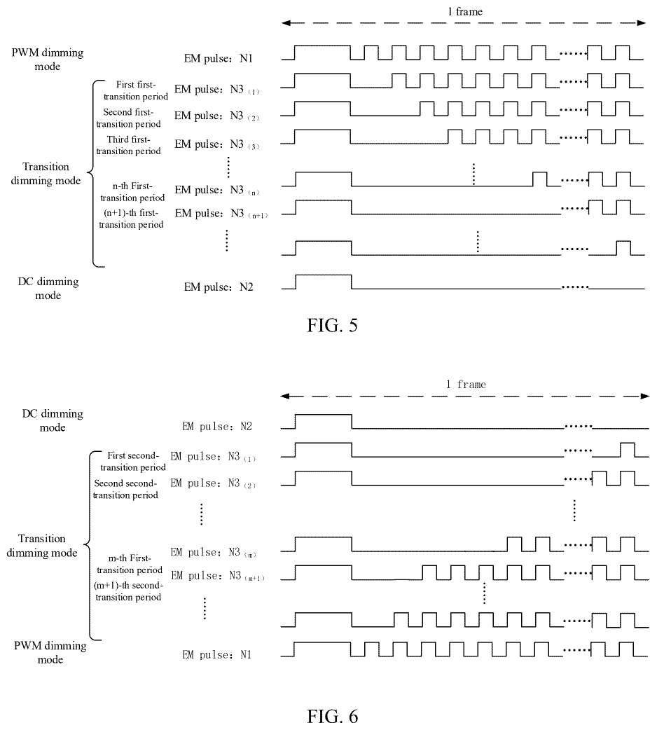

In some optional embodiments, as shown in FIG. 1, FIG. 2, and FIG. 6 which is another timing diagram of the light-emitting control circuit controlling the light-emitting control signal in one frame of the display screen under different dimming modes in the dimming method, when the DC dimming mode is switched to the PWM dimming mode, the transition dimming mode may include a plurality of second-transition dimming periods.

During the m-th second-transition dimming period, the number of pulses of the light-emitting control signal in one frame of the display screen controlled by the light-emitting control circuit 10 may be N3₍ₘ₎; and

during the (m+1)-th second-transition dimming period, the number of pulses of the light-emitting control signal in one frame of the display screen controlled by the light-emitting control circuit 10 may be N3(m+1); where m is a positive integer and the (m+1)-th second-transition dimming period is executed after the m-th second-transition dimming period, and N3₍ₘ₊₁₎>N3₍ₘ₎.

Optionally, 1≤N3₍ₘ₊₁₎−N3₍ₘ₎≤3.

In this embodiment, when the dimming mode of the display device is switched from the DC dimming mode at high brightness to the PWM dimming mode at low brightness, the transition dimming mode may be added before the PWM dimming mode is executed, and the transition dimming mode may include the plurality of second-transition dimming periods. The number of pulses of the light-emitting control signal EM in one frame of the display screen controlled by the light-emitting control circuit 10 in the DC dimming mode may be N3. In the plurality of second-transition dimming periods in the transition dimming mode, the number of pulses of the light-emitting control signal EM in one frame of the display screen controlled by the light-emitting control circuit 10 in the m-th second-transition dimming period may be N3₍ₘ₎, and the number of pulses of the light-emitting control signal EM in one frame of the display screen controlled by the light-emitting control circuit 10 in the (m+1)-th second-transition dimming period may be N3₍ₘ₊₁₎. N3₍ₘ₊₁₎>N3₍ₘ₎. For example, in the plurality of second-transition dimming periods in the transition dimming mode, during the first second-transition dimming period, the number of pulses of the light-emitting control signal EM controlled by the light-emitting control circuit 10 in one frame of the display screen may be N3₍₁₎; during the second second-transition dimming period, the number of pulses of the light-emitting control signal EM controlled by the light-emitting control circuit 10 in one frame of the display screen may be N3₍₂₎; during the third second-transition dimming period, the number of pulses of the light-emitting control signal EM controlled by the light-emitting control circuit 10 in one frame of the display screen may be N3₍₃₎, . . . , during the m-th second-transition dimming period, the number of pulses of the light-emitting control signal EM in one frame of the display screen controlled by the light-emitting control circuit 10 may be N3₍ₘ₎, and during the (m+1)-th second-transition dimming period, the number of pulses of the light-emitting control signal EM in one frame of the display screen controlled by the light-emitting control circuit 10 may be N3₍ₘ₊₁₎, where N3₍₁₎<N3₍₂₎<N3₍₃₎< . . . <N3₍ₘ₎<N3₍ₘ₊₁₎ . . . .

In this embodiment, before the display device switches from the DC dimming mode to the PWM dimming mode, during the plurality of second-transition dimming periods, the number of pulses of the light-emitting control signal EM may gradually increase, and 1≤N3₍ₘ₊₁₎−N3₍ₘ₎≤3. During two adjacent second-transition dimming periods, the number of pulses of the light-emitting control signal EM in the second-transition dimming period executed later may be 1-3 pulses more than the number of pulses of the light-emitting control signal EM in the second-transition dimming period executed earlier, to gradually transition to the PWM dimming mode for execution, thereby avoiding sudden brightness changes caused by differences in the light-emitting current, reducing instantaneous sudden brightness changes during the dimming process, effectively improving the visual effect, and ensuring the display effect of the display device.

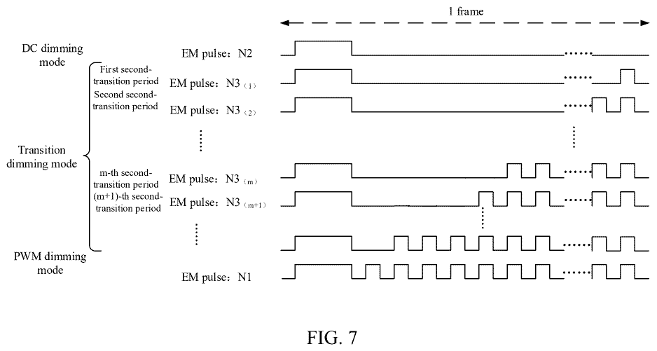

In some optional embodiments, as shown in FIG. 1, FIG. 2, and FIG. 7 which is another timing diagram of the light-emitting control circuit controlling the light-emitting control signal in one frame of the display screen under different dimming modes in the dimming method, during the (m−1)-th second-transition dimming period, the number of pulses of the light-emitting control signal controlled by the light-emitting control circuit 10 in one frame of the display screen may be N3₍ₘ₋₁₎; where N3₍ₘ₊₁₎−N3₍ₘ₎=N3₍ₘ₎−N3₍ₘ₋₁₎.

In the present embodiment, before the display device switches from the DC dimming mode to the PWM dimming mode, during the plurality of second-transition dimming periods in the transition dimming mode, the number of pulses of the light-emitting control signal EM may gradually increase, and 1≤N3₍ₘ₊₁₎−N3₍ₘ₎=N3₍ₘ₎−N3₍ₘ₋₁₎≤3. During two adjacent second-transition dimming periods, the number of pulses of the light-emitting control signal EM during the latter second-transition dimming period may be 1-3 pulses more than the number of pulses of the light-emitting control signal EM during the former second-transition dimming period. The number of pulses of the light-emitting control signal EM during the two adjacent second-transition dimming periods may be reduced by a same value, for example, as shown in FIG. 7, N3₍ₘ₊₁₎−N3₍ₘ₎=N3₍ₘ₎−N3₍ₘ₋₁₎=1. By uniformly adjusting the transition of the number of pulses of the light-emitting control signal EM, the transition to the DC dimming mode may be performed in a step-by-step manner, which may avoid brightness mutations caused by differences in light-emitting current, reduce instantaneous brightness mutations during the dimming process, effectively improve visual effects, ensure the display effect of the display device, and improve the uniformity of display brightness.

It can be understood that FIG. 7 of the present embodiment is only an example to illustrate the number of pulses of the light-emitting control signal EM during the plurality of second-transition dimming periods in the transition dimming mode. In specific implementations, the number of pulses in the light-emitting control signal EM during two adjacent second-transition dimming periods may be increased by a same value which may be 2 pulses or 3 pulses. It is only necessary to satisfy that the number of pulses increased in the light-emitting control signal EM during two adjacent second-transition dimming periods is the same.

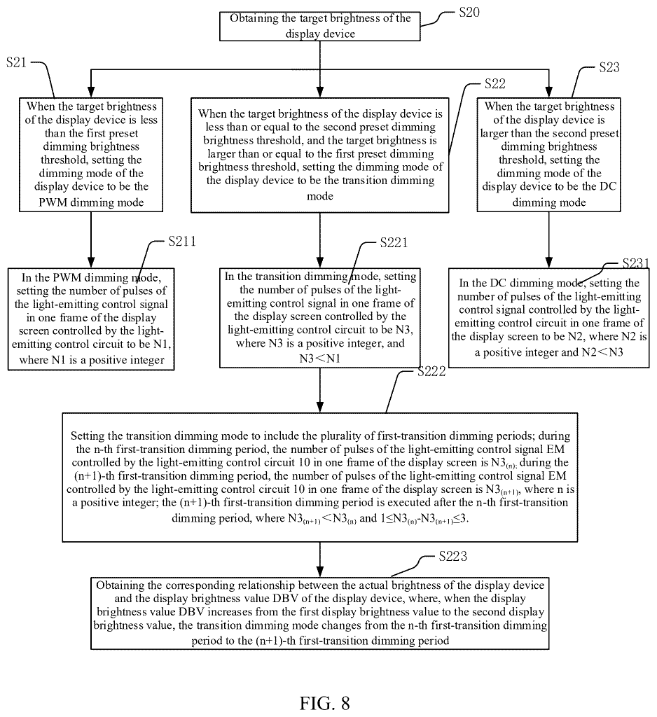

In some optional embodiments, as shown in FIG. 1 to FIG. 5, and FIG. 8 which is another flowchart of a dimming method for a display device, the dimming method for the display device may include:
S20, obtaining the target brightness of the display device;
S21, when the target brightness of the display device is less than the first preset dimming brightness threshold, setting the dimming mode of the display device to be the PWM dimming mode;
S211, in the PWM dimming mode, setting the number of pulses of the light-emitting control signal in one frame of the display screen controlled by the light-emitting control circuit to be N1, where N1 is a positive integer;
S22, when the target brightness of the display device is less than or equal to the second preset dimming brightness threshold, and the target brightness is larger than or equal to the first preset dimming brightness threshold, setting the dimming mode of the display device to be the transition dimming mode, where the first preset dimming brightness threshold is less than the second preset dimming brightness threshold;
S221, in the transition dimming mode, setting the number of pulses of the light-emitting control signal in one frame of the display screen controlled by the light-emitting control circuit to be N3, where N3 is a positive integer, and N3<N1;
S222: setting the transition dimming mode to include the plurality of first-transition dimming periods, where:
during the n-th first-transition dimming period, the number of pulses of the light-emitting control signal EM controlled by the light-emitting control circuit 10 in one frame of the display screen is N3₍ₙ₎;
during the (n+1)-th first-transition dimming period, the number of pulses of the light-emitting control signal EM controlled by the light-emitting control circuit 10 in one frame of the display screen is N3₍ₙ₊₁₎, where n is a positive integer; and
the (n+1)-th first-transition dimming period is executed after the n-th first-transition dimming period, where N3₍ₙ₊₁₎<N3₍ₙ₎ and 1≤N3₍ₙ₎−N3₍ₙ₊₁₎≤3;
S223, obtaining the corresponding relationship between the actual brightness of the display device and the display brightness value DBV of the display device, where, when the display brightness value DBV increases from the first display brightness value to the second display brightness value, the transition dimming mode changes from the n-th first-transition dimming period to the (n+1)-th first-transition dimming period.
S23, when the target brightness of the display device is larger than the second preset dimming brightness threshold, setting the dimming mode of the display device to be the DC dimming mode;
S231, in the DC dimming mode, setting the number of pulses of the light-emitting control signal controlled by the light-emitting control circuit in one frame of the display screen to be N2, where N2 is a positive integer and N2<N3.

In this embodiment, when the dimming mode of the display device is switched from the PWM dimming mode at low brightness to the DC dimming mode at high brightness, the transition dimming mode may be added before the DC dimming mode is executed, and the transition dimming mode may include the plurality of first-transition dimming periods. The number of pulses of the light-emitting control signal controlled by the light-emitting control circuit in one frame of the display screen during the n-th first-transition dimming period may change to the number of pulses of the light-emitting control signal controlled by the light-emitting control circuit in one frame of the display screen during the (n+1)-th first-transition dimming period, which may change with the change of the display brightness value DBV. In the process of adjusting the display brightness value DBV (Display Brightness Value) from one value to another, the actual brightness value of the display device may also change, and the DBV curve may be used to adjust the brightness of the display device. The DBV curve may represent the corresponding relationship between the display brightness value DBV and the actual brightness of the display device corresponding to a certain grayscale. For example, the DBV curve may represent the corresponding relationship between the display brightness value DBV and the actual brightness of the 255 grayscale of the display device. According to the DBV curve, the actual brightness corresponding to a certain grayscale of a display brightness value DBV may be obtained, and the gamma curve corresponding to the display brightness value DBV may be obtained according to the actual brightness corresponding to the obtained grayscale. The brightness of the display device may be adjusted using the obtained gamma curve, such that the display device may display the brightness corresponding to other grayscales under the display brightness value DBV.

Therefore, when executing the transition dimming mode, the corresponding relationship between the actual brightness of the display device and the display brightness value DBV of the display device may be obtained, and the display brightness value DBV may increase from the first display brightness value to the second display brightness value, that is, the transition dimming mode may change from the n-th first-transition dimming period to the (n+1)-th first-transition dimming period.

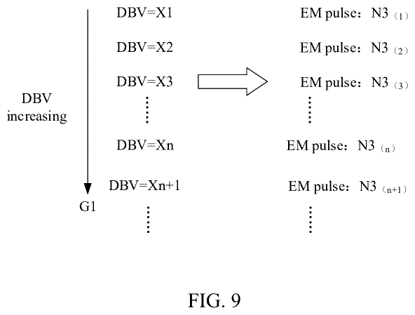

In one embodiment, as shown in FIG. 9 which is a diagram showing the corresponding setting relationship between the display brightness value and the number of pulses of the light-emitting control signal in the transition dimming mode of the display device, in the corresponding relationship between the actual brightness of the display device and the display brightness value DBV of the display device, the multiple display brightness values DBV may be X1, X2, . . . , Xn respectively. When X1 changes and increases to X2, the transition dimming mode may change from the first first-transition dimming period to the second first-transition dimming period, and the number of pulses of the light-emitting control signal may change from N3₍₁₎ to N3₍₂₎. When X2 changes and increases to X3, the transition dimming mode may change from the second first-transition dimming period to the third first-transition dimming period, and the number of pulses of the light-emitting control signal may change from N3₍₂₎ to N3₍₃₎, . . . , when Xn changes and increases to Xn+1 (the DBV increasing trend is shown by the arrow G1 in FIG. 9), the transition dimming mode may change from the n-th first-transition dimming period to the (n+1)-th first-transition dimming period, and the number of pulses of the light-emitting control signal may change from N3₍ₙ₎ to N3₍ₙ₊₁₎. That is, as the display brightness value DBV changes, the number of pulses of the light-emitting control signal in different first-transition dimming periods in the transition dimming mode may also change accordingly, X1 corresponds to N3₍₁₎, X2 corresponds to N3₍₂₎, . . . , Xn corresponds to N3₍ₙ₎, and Xn+1 corresponds to N3₍ₙ₊₁₎.

In this embodiment, when the display device executes the plurality of first-transition dimming periods of the transition dimming mode, the number of pulses of the light-emitting control signal may be gradually reduced in conjunction with the transition of the display brightness value DBV, thereby improving the color brightness flicker problem and achieving a sequential dimming effect by the corresponding change in the display brightness value to the change in the number of pulses of the light-emitting control signal, thereby effectively reducing the instantaneous brightness mutation during the dimming process, improving the visual effect, and ensuring the display effect of the display device.

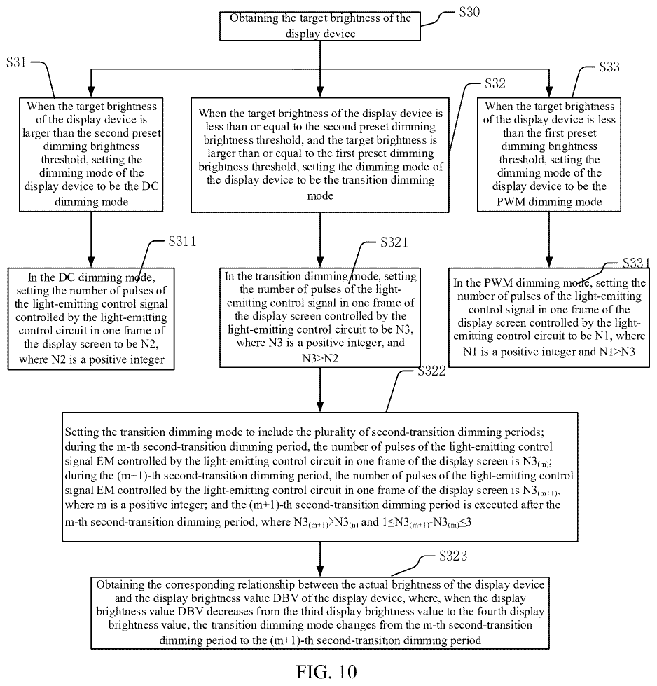

In some other optional embodiments, as shown in FIG. 1 to FIG. 3, FIG. 6, FIG. 7, and FIG. 10 which is another flowchart of a dimming method for a display device, the dimming method for the display device may include:
S30, obtaining the target brightness of the display device;
S31, when the target brightness of the display device is larger than the second preset dimming brightness threshold, setting the dimming mode of the display device to be the DC dimming mode;
S311, in the DC dimming mode, setting the number of pulses of the light-emitting control signal in one frame of the display screen controlled by the light-emitting control circuit to be N2, where N2 is a positive integer;
S32, when the target brightness of the display device is less than or equal to the second preset dimming brightness threshold, and the target brightness is larger than or equal to the first preset dimming brightness threshold, setting the dimming mode of the display device to be the transition dimming mode, where the first preset dimming brightness threshold is less than the second preset dimming brightness threshold;
S321, in the transition dimming mode, setting the number of pulses of the light-emitting control signal in one frame of the display screen controlled by the light-emitting control circuit to be N3, where N3 is a positive integer, and N3>N2;
S322, setting the transition dimming mode to include the plurality of second-transition dimming periods, where:
during the m-th second-transition dimming period, the number of pulses of the light-emitting control signal EM controlled by the light-emitting control circuit 10 in one frame of the display screen is N3₍ₘ₎;
during the (m+1)-th second-transition dimming period, the number of pulses of the light-emitting control signal EM controlled by the light-emitting control circuit 10 in one frame of the display screen is N3₍ₘ₊₁₎, where m is a positive integer; and
the (m+1)-th second-transition dimming period is executed after the m-th second-transition dimming period, where N3₍ₘ₊₁₎>N3₍ₙ₎ and 1≤N3₍ₘ₊₁₎−N3₍ₘ₎≤3;
S323, obtaining the corresponding relationship between the actual brightness of the display device and the display brightness value DBV of the display device, where, when the display brightness value DBV decreases from the third display brightness value to the fourth display brightness value, the transition dimming mode changes from the m-th second-transition dimming period to the (m+1)-th second-transition dimming period.
S23, when the target brightness of the display device is smaller than the first preset dimming brightness threshold, setting the dimming mode of the display device to be the PWM dimming mode;
S231, in the PWM dimming mode, setting the number of pulses of the light-emitting control signal controlled by the light-emitting control circuit in one frame of the display screen to be N1, where N1 is a positive integer and N1>N3.

In this embodiment, when the dimming mode of the display device is switched from the DC dimming mode at high brightness to the PWM dimming mode at low brightness, the transition dimming mode may be added before the PWM dimming mode is executed, and the transition dimming mode may include the plurality of second-transition dimming periods. The number of pulses of the light-emitting control signal controlled by the light-emitting control circuit in one frame of the display screen during the m-th second-transition dimming period may change to the number of pulses of the light-emitting control signal controlled by the light-emitting control circuit in one frame of the display screen during the (m+1)-th second-transition dimming period, which may change with the change of the display brightness value DBV. In the process of adjusting the display brightness value DBV (Display Brightness Value) from one value to another, the actual brightness value of the display device may also change, and the DBV curve may be used to adjust the brightness of the display device. The DBV curve may represent the corresponding relationship between the display brightness value DBV and the actual brightness of the display device corresponding to a certain grayscale. For example, the DBV curve may represent the corresponding relationship between the display brightness value DBV and the actual brightness of the 255 grayscale of the display device. According to the DBV curve, the actual brightness corresponding to a certain grayscale of a display brightness value DBV may be obtained, and the gamma curve corresponding to the display brightness value DBV may be obtained according to the actual brightness corresponding to the obtained grayscale. The brightness of the display device may be adjusted using the obtained gamma curve, such that the display device may display the brightness corresponding to other grayscales under the display brightness value DBV.

Therefore, when executing the transition dimming mode, the corresponding relationship between the actual brightness of the display device and the display brightness value DBV of the display device may be obtained, and the display brightness value DBV may decrease from the third display brightness value to the fourth display brightness value, that is, the transition dimming mode may change from the m-th second-transition dimming period to the (m+1)-th second-transition dimming period.

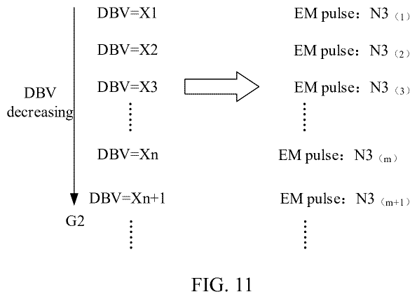

In one embodiment, as shown in FIG. 11 which is a diagram showing the corresponding setting relationship between the display brightness value and the number of pulses of the light-emitting control signal in the transition dimming mode of the display device, in the corresponding relationship between the actual brightness of the display device and the display brightness value DBV of the display device, the multiple display brightness values DBV may be X1, X2, . . . , Xn respectively. When X1 changes and decreases to X2, the transition dimming mode may change from the first second-transition dimming period to the second second-transition dimming period, and the number of pulses of the light-emitting control signal may change from N3₍₁₎ to N3₍₂₎. When X2 changes and decreases to X3, the transition dimming mode may change from the second second-transition dimming period to the third second-transition dimming period, and the number of pulses of the light-emitting control signal may change from N3₍₂₎ to N3₍₃₎, . . . , when Xn changes and decreases to Xn+1 (the DBV increasing trend is shown by the arrow G1 in FIG. 9), the transition dimming mode may change from the m-th second-transition dimming period to the (m+1)-th second-transition dimming period, and the number of pulses of the light-emitting control signal may change from N3₍ₘ₎ to N3₍ₘ₊₁₎. That is, as the display brightness value DBV changes, the number of pulses of the light-emitting control signal in different second-transition dimming periods in the transition dimming mode may also change accordingly, X1 corresponds to N3₍₁₎, X2 corresponds to N3₍₂₎, . . . , Xn corresponds to N3₍ₘ₎, and Xn+1 corresponds to N3₍ₘ₊₁₎.

In this embodiment, when the display device executes the plurality of second-transition dimming periods of the transition dimming mode, the number of pulses of the light-emitting control signal may be gradually increased in conjunction with the transition of the display brightness value DBV, thereby improving the color brightness flicker problem and achieving a sequential dimming effect by the corresponding change in the display brightness value to the change in the number of pulses of the light-emitting control signal, thereby effectively reducing the instantaneous brightness mutation during the dimming process, improving the visual effect, and ensuring the display effect of the display device.

Optionally, in this embodiment, the first preset dimming brightness threshold may be less than the second preset dimming brightness threshold. When the target brightness of the display device is less than the first preset dimming brightness threshold, the dimming mode of the display device may be set to the PWM dimming mode. When the target brightness of the display device is larger than the second preset dimming brightness threshold, the dimming mode of the display device may be set to the DC dimming mode. The first preset dimming brightness threshold may be larger than 0 nit, and the second preset dimming brightness threshold may be less than or equal to 90 nit. That is, the display device may adopt the DC dimming mode under high brightness and the PWM dimming mode under low brightness. During actual dimming, the PWM dimming mode may be adopted when the target brightness of the display device is about 0 to 90 nit, and the display device may be switched to the DC dimming mode when the target brightness of the display device is above 90 nit. Therefore, after adding the transition dimming mode in this embodiment, the first preset dimming brightness threshold may be any brightness larger than 0 nit and the second preset dimming brightness threshold may be any brightness less than or equal to 90 nit. For example, the first preset dimming brightness threshold may be 70 nit, and the second preset dimming brightness threshold may be 80 nit. When the target brightness of the display device is less than 70 nit, the dimming mode of the display device may be set to the PWM dimming mode; and, when the target brightness of the display device is larger than 80 nit, the dimming mode of the display device may be set to the DC dimming mode; and, when the target brightness of the display device is between 70 nit and 80 nit, the dimming mode of the display device may be set to the transitional dimming mode.

Optionally, in some embodiments, the first preset dimming brightness threshold may be a non-zero brightness close to 0 nit. For example, the first preset dimming brightness threshold may be 5 nit, and the second preset dimming brightness threshold may be 20 nit. When the target brightness of the display device is less than 5 nit, the dimming mode of the display device may be set to the PWM dimming mode; when the target brightness of the display device is larger than 20 nit, the dimming mode of the display device may be set to the DC dimming mode; and, when the target brightness of the display device is between 5 nit and 20 nit, the dimming mode of the display device may be set to the transitional dimming mode. Therefore, the dimming mode of the display device may be approximately inclined to adopt the DC dimming mode. The screen brightness may be adjusted by directly adjusting the voltage or current. The change of brightness may be achieved by adjusting the magnitude of the voltage or current, such that the brightness adjustment process is very smooth, which is conducive to improving the display effect.

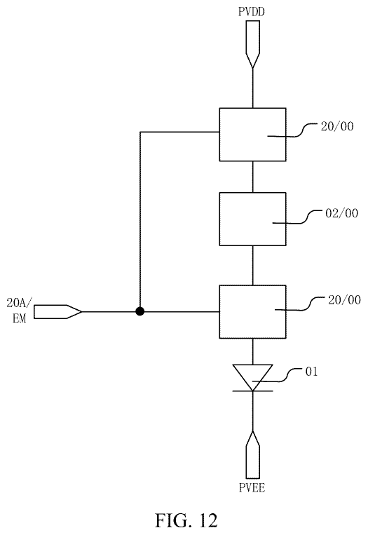

In some optional embodiments, as shown in FIG. 1, FIG. 2, and FIG. 12 which is a schematic diagram of the electrical connection structure between the pixel circuit and the light-emitting element in FIG. 2, the display device may include a display area AA and a non-display area NA. The display area AA may include a pixel circuit 00 and a light-emitting element 01. The pixel circuit 00 may include a first power supply terminal PVDD, a second power supply terminal PVEE, a driving module 02 and a light-emitting module 20. The driving module 02, the light-emitting module 20 and the light-emitting element 01 may be electrically connected between the first power supply terminal PVDD and the second power supply terminal PVEE.

The non-display area NA may include a light-emitting control circuit 10, and the output end of the light-emitting control circuit 10 may be electrically connected to the control end 20A of the light-emitting module 20.

In this embodiment, the display device 000 may include the display area AA and the non-display area NA. The display area AA may include a plurality of sub-pixels of different colors. Each sub-pixel may include an electrically connected pixel circuit 00 and a light-emitting element 01. The pixel circuit 00 may include a first power terminal PVDD, a second power terminal PVEE, a driving module 02 and a light-emitting module 20. The driving module 02, the light-emitting module 20 and the light-emitting element 01 may be electrically connected between the first power terminal PVDD and the second power terminal PVEE. The light-emitting module 20 in the pixel circuit 00 may be controlled by the light-emitting control circuit 10 located in the non-display area NA outside the display area AA. The light-emitting control circuit 10 may provide the light-emitting control signal EM to the control terminal 20A of the light-emitting module 20. The display device 000 may provide a clock signal, VGH, VGL and other signals to the light-emitting control circuit 10 through a display driving chip such as DDIC, such that the light-emitting control circuit 10 generates the light-emitting control signal EM to the control terminal 20A of the light module 20 in the pixel circuit of the display area AA to control the on and off of the light module 20. Therefore, a conductive path may be formed between the first power terminal PVDD, the driving module 02, the light-emitting element 01 and the second power terminal PVEE, and a driving current may be generated to drive the light-emitting elements 01 of different sub-pixels in the display area AA to emit light, thereby completing the display.

In this embodiment, the light-emitting control circuit 10 may control the number of pulses of the light-emitting control signal EM to be different, and the display device 000 may provide the clock signals, VGH, VGL and other signals to the light-emitting control circuit 10 through the display driving chip such as DDIC. Therefore, the light-emitting control signal EM provided by the light-emitting control circuit 10 may be controlled by the display driving chip to achieve the number of pulses of the light-emitting control signal N3 in the transition dimming mode required by the above embodiments. The dimming method of this embodiment may not need to increase the hardware structure of the display device 000, such that the manufacturing cost may be saved. The pulse number adjustment of the light-emitting control signal EM provided by the light-emitting control circuit 10 may be realized only through the integrated control of the display driving chip, which may be beneficial to improve the brightness mutation problem and save the overall manufacturing cost of the display device.

It should be noted that FIG. 12 of this embodiment is only a block diagram illustrating the structure of the pixel circuit such as the driving module and the light-emitting module. When it is implemented, the structure of the pixel circuit 00 may be understood by referring to the structure of the OLED display panel in the existing technologies, and this embodiment will not be described in detail.

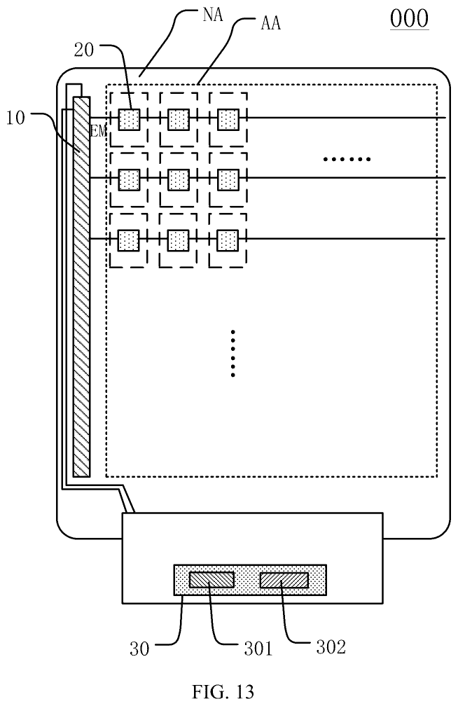

In some optional embodiments, as shown in FIG. 1, FIG. 2, FIG. 12, and FIG. 13 which is another structural schematic diagram of a display device using the dimming method of FIG. 1, the display device 000 may include a driving chip 30, and the light-emitting control circuit 10 may be electrically connected to the driving chip 30.

The driving chip 30 may include a storage module 301 and a processor module 302.

A plurality of groups of relationship comparison tables may be preset, and each group of relationship comparison tables may include a corresponding relationship between multiple different display brightness values DBV of the display device and different numbers of pulses of the light-emitting control signal EM in one frame of the display screen controlled by the light-emitting control circuit 10 in the transition dimming mode.

The plurality of groups of relationship comparison tables may be stored in the storage module 301 or the processor module 302.

In this embodiment, the display device 000 may include the driving chip 30, and the driving chip 30 may be a display driving chip DDIC. The light-emitting control circuit 10 may be electrically connected to the driving chip 30. Optionally, the driving chip 30 may be electrically connected to the binding area of the display panel included in the display device 000 through a flexible circuit board, and the binding area of the display panel may be electrically connected to the light-emitting control circuit 10 through a fan-out line and a peripheral line, such that the driving chip 30 provides the light-emitting control circuit 10 with clock signals, VGH, VGL and other signals. This embodiment does not elaborate on the arrangement structure of the driving chip 30 on the display device 000 and the specific electrical connection relationship with the light-emitting control circuit 10, which may be understood by referring to the structure of the OLED display device in the existing technologies.

The driving chip 30 may include the storage module 301 and the processor module 302. The storage module 301 may be a Flash IC, that is, a Flash memory chip. In applications that need to store a large amount of data, the Flash IC may play a role in storing data. The processor module 302 may be an AP end, that is, an application processor end, which is a key part for processing and displaying data. That is, the driving part of the general display device 000 may need to include a storage module 301 and a processor module 302 to store a large amount of driving data for driving the display. To realize the different pulse numbers of the light-emitting control signal EM in one frame of the display screen controlled by the light-emitting control circuit 10 during the plurality of transition dimming periods in the transition dimming mode, the plurality of groups of relationship comparison tables may be preset, and each group of relationship comparison tables may include the corresponding relationship between the multiple different display brightness values DBV of the display device 000 and the different pulse numbers of the light-emitting control signal EM in one frame of the display screen controlled by the light-emitting control circuit 10 in the transition dimming mode. The plurality of groups of relationship comparison tables may be stored in the storage module 301 or the processor module 302, to control the driving chip 30 to adjust the different pulse numbers of the light-emitting control signal EM in different transition dimming periods in real time according to one group of relationship comparison tables, and then control the output of the light-emitting control circuit 10 to realize the transition adjustment of the pulse number of the light-emitting control signal EM in different transition dimming periods in different transition dimming modes.

In this embodiment, the plurality of groups of relationship comparison tables may be preset and pre-stored in the storage module 301 or the processor module 302 of the driving chip 30. The plurality of groups of relationship comparison tables may be called in real time when needed, and the hardware structure of the display device 000 may not change. It may be only necessary to store the plurality of groups of preset relationship comparison tables in the storage module 301 or the processor module 302 in advance when the driving chip 30 is fired. The production cost of the display device 000 may not increase, which is beneficial to saving production costs.

Optionally, because of the different characteristics of different display devices, it may be necessary to preset the plurality of groups of relationship comparison tables. In actual use, different choices may be made according to different panels, and one group of relationship comparison tables may be selected to execute the transition dimming mode to achieve the best visual effect of the dimming of the display device and ensure the display quality.

Optionally, one relationship comparison table may include multiple display brightness values DBV, and the multiple display brightness values DBV may be X1, X2, . . . , Xn respectively.

The relationship comparison table may also include the number of pulses of multiple light-emitting control signals EM, that is, the number of pulses. The number of pulses of the multiple light-emitting control signals EM may be N3₍₁₎, N3₍₂₎, . . . , N3₍ₙ₎ respectively; where, X1 corresponds to N3₍₁₎, X2 corresponds to N3₍₂₎, . . . , and Xn corresponds to N3₍ₙ₎.

In this embodiment, the plurality of groups of relationship comparison tables may be stored in the storage module 301 or the processor module 302 of the driving chip 30. The relationship comparison table may include multiple display brightness values DBV, and the multiple display brightness values DBV may be respectively X1, X2, . . . , Xn. The relationship comparison table may also include the number of pulses of the multiple light-emitting control signals EM, that is, the pulse numbers, and the pulse numbers of the multiple light-emitting control signals EM may be respectively N3₍₁₎, N3₍₂₎, . . . , N3₍ₙ₎ respectively; where, X1 corresponds to N3₍₁₎, X2 corresponds to N3₍₂₎, . . . , and Xn corresponds to N3₍ₙ₎. Table 1 shown below is a group of relationship comparison tables exemplified by the embodiment of the present disclosure.

TABLE 1

| | DBV (X1, X2, . . . , | EM pulse number (N3₍₁₎, |
|---|---|---|
| | Xn) | N3₍₂₎, . . . , N3₍ₙ₎) |
| Transition | 1000 | 36 |
| dimming | 1001 | 33 |
| mode: the | 1002 | 30 |
| target | 1003 | 27 |
| brightness | 1004 | 24 |
| larger than or | 1005 | 21 |
| equal to 73.5 | 1006 | 18 |
| nit, and | 1007 | 15 |
| smaller than | 1008 | 12 |
| or equal to 75 | 1009 | 9 |
| nit | 1010 | 6 |
| | 1011 | 3 |

In one embodiment, as shown in Table 1, the first preset dimming brightness threshold may be 73.5 nit, and the second preset dimming brightness threshold may be 75 nit. When the target brightness of the display device 000 is less than 73.5 nit, the PWM dimming mode may be adopted. When the target brightness of the display device 000 is larger than 75 nit, the DC dimming mode may be adopted. When the target brightness of the display device 000 is between 73.5 nit and 75 nit, the transition dimming mode may be adopted. In the transition dimming mode, the number of pulses of the light-emitting control signal EM during the first-transition dimming periods, i.e., the pulse number, may decrease as the display brightness value DBV increases. As shown in Table 1, for example, X1 of the display brightness value DBV is 1000, and the number of pulses N3₍₁₎ of the light-emitting control signal EM during the first-transition dimming period is 36. X2 of the display brightness value DBV is 1001, and the number of pulses N3₍₂₎ of the light-emitting control signal EM during the second first-transition dimming period is 33. X3 of the display brightness value DBV is 1002, and the number of pulses N3₍₃₎ of the light-emitting control signal EM during the third first-transition dimming period is 30, . . . . Before switching to the DC dimming mode, the display brightness value DBV is 1011, and the number of pulses of the light-emitting control signal EM during the last first-transition dimming period is 3, and the number of pulses N2 of the light-emitting control signal EM after switching to the DC dimming mode is 1. The relationship comparison table may be set in this way, such that the number of pulses of the light-emitting control signal EM of the light-emitting control circuit 10 may be called to control the light-emitting control circuit 10 when the transition dimming mode needs to be implemented. It may be flexible and convenient, and the problem of sudden brightness change when the dimming mode is switched may be improved, thereby improving the display quality.

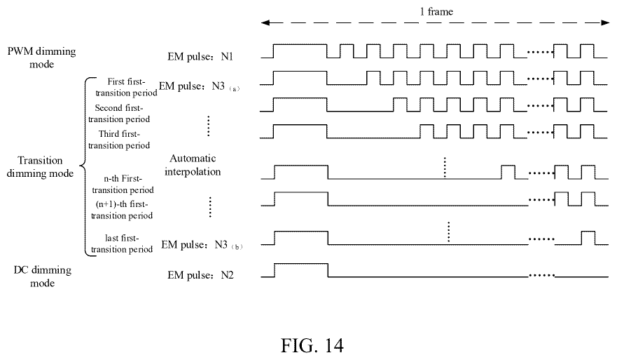

In some optional embodiments, as shown in FIG. 2, FIG. 12, FIG. 13, and FIG. 14 which is another timing diagram of the light-emitting control circuit controlling the light-emitting control signal in one frame of the display screen under different dimming modes in the dimming method, the display device may further include a first automatic interpolation module. Optionally, the first automatic interpolation module may be integrated in the driving chip 30 to control the display device 000.

The plurality of first-transition dimming periods may include a first first-transition dimming period and a last first-transition dimming period. During the first first-transition dimming period, the light-emitting control circuit 10 may control the number of pulses of the light-emitting control signal in one frame of the display screen to be N3₍ₐ₎. During the last first-transition dimming period, the light-emitting control circuit 10 may control the number of pulses of the light-emitting control signal in one frame of the display screen to be N3_{(b)}.

The first automatic interpolation module may be configured to automatically interpolate and obtain the number of pulses of the light-emitting control signal in one frame of the display screen during the others of the plurality of first-transition dimming periods according to N3₍ₐ₎ and N3_{(b)}.

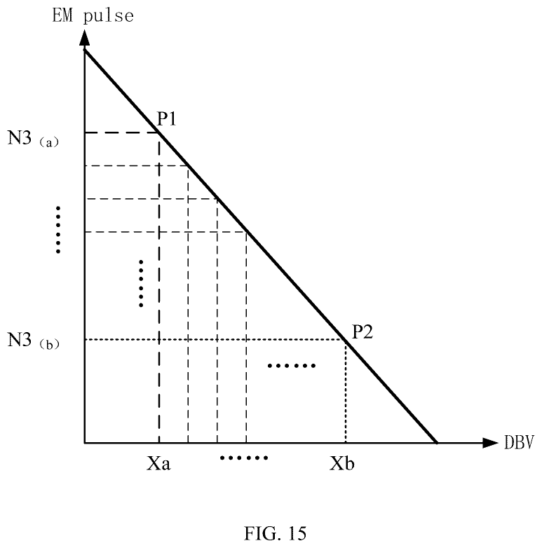

Optionally, the interpolation method of the first automatic interpolation module may include: the first automatic interpolation module determines, according to the linear relationship diagram between the display brightness value DBV and the number of pulses of the light-emitting control signal EM, that the display brightness value of the display device 000 is Xa and the number of pulses of the light-emitting control signal EM controlled by the light-emitting control circuit 10 in one frame of the display screen is N3₍ₐ₎ during the first first-transition dimming period; and, the first automatic interpolation module determines that the display brightness value of the display device 000 is Xb and the number of pulses of the light-emitting control signal EM controlled by the light-emitting control circuit 10 in one frame of the display screen is N3_{(b)} during the last first-transition dimming period, as shown in FIG. 15 which is a linear relationship diagram between the display brightness value and the number of pulses of the light-emitting control signal, where the abscissa of the linear relationship diagram is the display brightness value DBV and the ordinate is the number of pulses of the light-emitting control signal EM (EM pulse number); and the first automatic interpolation module automatically interpolates and obtains the number of pulses of the light-emitting control signal EM in one frame of the display screen controlled by the light-emitting control circuit 10 during others of the plurality of first-transition dimming periods, corresponding to different display brightness values DBV, based on the first starting point P1 determined by the horizontal coordinate Xa and the vertical coordinate N3₍ₐ₎ and the first ending point P2 determined by the horizontal coordinate Xb and the vertical coordinate N3_{(b)} in the linear relationship diagram.

In this embodiment, before the display device 000 switches from the low-brightness PWM dimming mode to the high-brightness DC dimming mode, the transition dimming mode may be added. The number of pulses of the light-emitting control signal EM during the plurality of first-transition dimming periods of the transition dimming mode may be determined without the need for preset corresponding relationship tables between the display brightness value DBV and the number of pulses of the light-emitting control signal EM. For example, during the plurality of first-transition dimming periods, the number of pulses of the light-emitting control signal in one frame of the display screen controlled by the light-emitting control circuit during the n-th first-transition dimming period may change to the number of pulses of the light-emitting control signal in one frame of the display screen controlled by the light-emitting control circuit during the (n+1)-th first-transition dimming period, which may change with the change of the display brightness value DBV. Only the number of pulses of the light-emitting control signal EM in one frame of the display screen controlled by the light-emitting control circuit 10 during the first first-transition dimming period and the number of pulses of the light-emitting control signal EM in one frame of the display screen controlled by the light-emitting control circuit 10 during the last first-transition dimming period may need to be determined, and the number of pulses of the light-emitting control signal EM in others of the plurality of first-transition dimming periods may be obtained by automatic interpolation. The display device 000 may include the first automatic interpolation module, and the first automatic interpolation module may be integrated into the driving chip 30 to control the display device 000. The display brightness value DBV may be linearly related to the number of pulses of the light-emitting control signal EM, and the linear relationship diagram may be as shown in FIG. 15, where the horizontal axis is the display brightness value DBV and the vertical axis is the number of pulses of the light-emitting control signal EM (EM pulse number). According to the linear relationship diagram, the first automatic interpolation module may determine that the display brightness value of the display device 000 is Xa and the number of pulses of the light-emitting control signal EM in one frame of the display screen controlled by the light-emitting control circuit 10 is N3₍ₐ₎ during the first first-transition dimming period. The horizontal coordinate Xa and the vertical coordinate N3₍ₐ₎ may determine the first starting point. According to the linear relationship diagram, the first automatic interpolation module may determine that, during the last first-transition dimming period, the display brightness value of the display device 000 is Xb and the number of pulses of the light-emitting control signal EM in one frame of the display screen controlled by the light-emitting control circuit 10 is N3_{(b)}. The horizontal coordinate Xb and the vertical coordinate N3_{(b)} may determine the first ending point. Then, during the others of the plurality of first-transition dimming periods, the number of pulses of the light-emitting control signal EM in one frame of the display screen controlled by the light-emitting control circuit 10 corresponding to different display brightness values DBV may be obtained by automatic interpolation. In the dimming method of the transition dimming mode of the present embodiment, it may only need to preset the number of pulses of the light-emitting control signal EM corresponding to the display brightness value DBV at the first first-transition dimming period and the last first-transition dimming period, and the number of pulses of the light-emitting control signal EM in the first-transition dimming periods of the intermediate state may be automatically interpolated by the first automatic interpolation module, and the number of pulses of the light-emitting control signal EM in the plurality of first-transition dimming periods of the intermediate state may not need to be preset, which is beneficial to save the driving power consumption of the driving chip, and further beneficial to reducing the overall driving power consumption of the display device.

The linear relationship diagram of the display brightness value DBV and the number of pulses of the light-emitting control signal EM in the transition dimming mode of FIG. 15 of the present embodiment is used only for indicating that in the transition dimming mode added during the switching of the display device 000 from the PWM dimming mode to the DC dimming mode, during multiple first-transition dimming periods, as the display brightness value DBV increases, the number of pulses of the light-emitting control signal EM in a frame of the display screen controlled by the light-emitting control circuit 10 is in a decreasing linear relationship, and is used as an example to illustrate the present disclosure. In various implementations, the above linear relationship diagram may be set according to actual conditions.

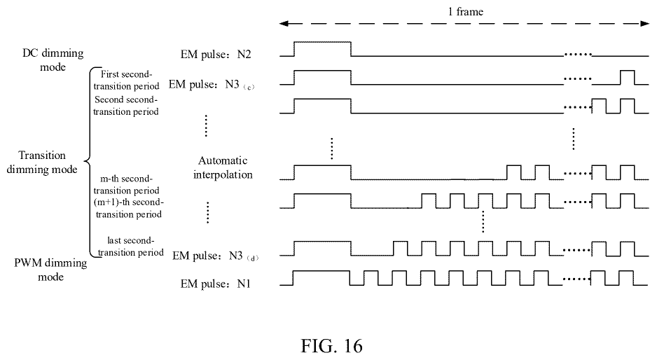

In some optional embodiments, as shown in FIG. 2, FIG. 12, FIG. 13, and FIG. 16 which is another timing diagram of the light-emitting control circuit controlling the light-emitting control signal in one frame of the display screen under different dimming modes in the dimming method, the display device may further include a second automatic interpolation module. Optionally, the second automatic interpolation module may be integrated into the driving chip 30 to control the display device 000.

The plurality of second-transition dimming periods may include a first second-transition dimming period and a last second-transition dimming period. During the first second-transition dimming period, the light-emitting control circuit 10 may control the number of pulses of the light-emitting control signal in one frame of the display screen to be N3_{(c)}. During the last second-transition dimming period, the light-emitting control circuit 10 may control the number of pulses of the light-emitting control signal in one frame of the display screen to be N3_{(d)}.

The second automatic interpolation module may be configured to automatically interpolate and obtain the number of pulses of the light-emitting control signal in one frame of the display screen during the others of the plurality of second-transition dimming periods according to N3_{(c)} and N3_{(d)}.

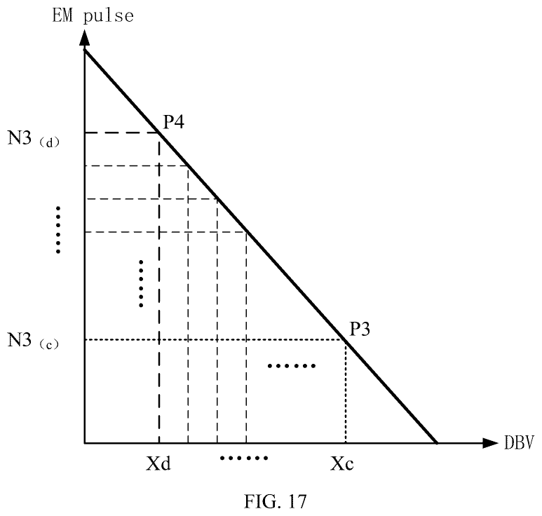

Optionally, the interpolation method of the second automatic interpolation module may include: the second automatic interpolation module determines, according to the linear relationship diagram between the display brightness value DBV and the number of pulses of the light-emitting control signal EM, that the display brightness value of the display device 000 is Xc and the number of pulses of the light-emitting control signal EM controlled by the light-emitting control circuit 10 in one frame of the display screen is N3_{(c)} during the first second-transition dimming period; and, the second automatic interpolation module determines that the display brightness value of the display device 000 is Xd and the number of pulses of the light-emitting control signal EM controlled by the light-emitting control circuit 10 in one frame of the display screen is N3_{(d)} during the last second-transition dimming period, as shown in FIG. 17 which is a linear relationship diagram between the display brightness value and the number of pulses of the light-emitting control signal, where the abscissa of the linear relationship diagram is the display brightness value DBV and the ordinate is the number of pulses of the light-emitting control signal EM (EM pulse number); and the second automatic interpolation module automatically interpolates and obtains the number of pulses of the light-emitting control signal EM in one frame of the display screen controlled by the light-emitting control circuit 10 during others of the plurality of second-transition dimming periods, corresponding to different display brightness values DBV, based on the second starting point P3 determined by the horizontal coordinate Xc and the vertical coordinate N3_{(c)} and the second ending point P4 determined by the horizontal coordinate Xd and the vertical coordinate N3_{(d)} in the linear relationship diagram.

In this embodiment, before the display device 000 switches from the high-brightness DC dimming mode to the low-brightness PWM dimming mode, the transition dimming mode may be added. The number of pulses of the light-emitting control signal EM during the plurality of second-transition dimming periods of the transition dimming mode may be determined without the need for preset corresponding relationship tables between the display brightness value DBV and the number of pulses of the light-emitting control signal EM. For example, during the plurality of second-transition dimming periods, the number of pulses of the light-emitting control signal in one frame of the display screen controlled by the light-emitting control circuit during the m-th second-transition dimming period may change to the number of pulses of the light-emitting control signal in one frame of the display screen controlled by the light-emitting control circuit during the (m+1)-th second-transition dimming period, which may change with the change of the display brightness value DBV. Only the number of pulses of the light-emitting control signal EM in one frame of the display screen controlled by the light-emitting control circuit 10 during the first second-transition dimming period and the number of pulses of the light-emitting control signal EM in one frame of the display screen controlled by the light-emitting control circuit 10 during the last second-transition dimming period may need to be determined, and the number of pulses of the light-emitting control signal EM in others of the plurality of second-transition dimming periods may be obtained by automatic interpolation. The display device 000 may include the second automatic interpolation module, and the second automatic interpolation module may be integrated in the driving chip 30 to control the display device 000. The display brightness value DBV may be linearly related to the number of pulses of the light-emitting control signal EM, and the linear relationship diagram may be as shown in FIG. 17, where the horizontal axis is the display brightness value DBV and the vertical axis is the number of pulses of the light-emitting control signal EM (EM pulse number). According to the linear relationship diagram, the second automatic interpolation module may determine that the display brightness value of the display device 000 is Xc and the number of pulses of the light-emitting control signal EM in one frame of the display screen controlled by the light-emitting control circuit 10 is N3_{(c)} during the first second-transition dimming period. The horizontal coordinate Xc and the vertical coordinate N3_{(c)} may determine the second starting point. According to the linear relationship diagram, the second automatic interpolation module may determine that, during the last second-transition dimming period, the display brightness value of the display device 000 is Xd and the number of pulses of the light-emitting control signal EM in one frame of the display screen controlled by the light-emitting control circuit 10 is N3_{(d)}. The horizontal coordinate Xd and the vertical coordinate N3_{(d)} may determine the second ending point. Then, during the others of the plurality of second-transition dimming periods, the number of pulses of the light-emitting control signal EM in one frame of the display screen controlled by the light-emitting control circuit 10 corresponding to different display brightness values DBV may be obtained by automatic interpolation. In the dimming method of the transition dimming mode of the present embodiment, it may only need to preset the number of pulses of the light-emitting control signal EM corresponding to the display brightness value DBV at the first second-transition dimming period and the last second-transition dimming period, and the number of pulses of the light-emitting control signal EM in the second-transition dimming periods of the intermediate state may be automatically interpolated by the second automatic interpolation module, and the number of pulses of the light-emitting control signal EM in the plurality of second-transition dimming periods of the intermediate state may not need to be preset, which is beneficial to saving the driving power consumption of the driving chip, and further beneficial to reducing the overall driving power consumption of the display device.

The linear relationship diagram of the display brightness value DBV and the number of pulses of the light-emitting control signal EM in the transition dimming mode of FIG. 17 of the present embodiment is used only for indicating that in the transition dimming mode added during the switching of the display device 000 from the DC dimming mode to the PWM dimming mode, during multiple second-transition dimming periods, as the display brightness value DBV increases, the number of pulses of the light-emitting control signal EM in one frame of the display screen controlled by the light-emitting control circuit 10 is in a decreasing linear relationship, and is used as an example to illustrate the present disclosure. In various implementations, the above linear relationship diagram may be set according to actual conditions.

In one embodiment, as shown in FIG. 2, FIG. 12, FIG. 13, FIG. 14, and FIG. 16, the light-emitting control circuit 10 may control the pulse width of the light-emitting control signal EM to be the same within one frame of the display screen. That is, in the transition dimming mode provided in this embodiment, during the plurality of different first-transition dimming periods and the plurality of different second-transition dimming periods, the number of pulses of the light-emitting control signal EM may be adjusted, and there may be no need to adjust the pulse width of the light-emitting control signal EM in a transitional manner. The pulse widths of the light-emitting control signal EM may all be the same, which may make the adjustment method of the transition dimming mode more intuitive and flexible, and the number of pulses of the light-emitting control signal EM may be set directly and flexibly without the need for complicated adjustment of the duty cycle, which may effectively improve the visual effect, avoid sudden changes in brightness, and also help to simplify the dimming steps and reduce the complexity of the dimming process.

The present disclosure also provides a display device, as shown in FIG. 2 or FIG. 13. The display device may be dimmed using the dimming method provided by any of the above embodiments. It may be understood that the display device may be a display device with a display function such as a computer, a television, a car display device, etc., and the present disclosure does not make specific restrictions on this. The display device provided by the present disclosure may have the beneficial effects of the display device adopting the above dimming method. For details, references may be made to the specific descriptions of the above embodiments, which will not be repeated here.

In the present disclosure, relational terms such as “first” and “second” are only used to distinguish one entity or operation from another entity or operation, and do not necessarily require or imply that there is a relationship between these entities or operations. There is no such actual relationship or sequence. Furthermore, the terms “comprises”, “include”, or any other variations thereof are intended to cover a non-exclusive inclusion such that a process, method, article, or apparatus that includes a list of elements includes not only those elements, but also those not expressly listed, or elements inherent to the process, method, article or equipment. Without further limitation, an element defined by the statement “comprises a . . . ” does not exclude the presence of additional identical elements in a process, method, article, or apparatus that includes the stated element.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. A dimming method of a display device, comprising:
obtaining a target brightness of the display device;
when the target brightness is less than a first preset dimming brightness threshold, setting a dimming mode of the display device to a PWM dimming mode; and
when the target brightness is larger than a second preset dimming brightness threshold, setting the dimming mode of the display device to a DC dimming mode; wherein the first preset dimming brightness threshold is less than the second preset dimming brightness threshold,
wherein:
the display device includes a light-emitting control circuit and a light-emitting module;
the light-emitting control circuit is electrically connected to the light-emitting module;
the light-emitting control circuit is used to provide a light-emitting control signal to the light-emitting module;
the display device further has a transition dimming mode;
when the target brightness is less than or equal to the second preset dimming brightness threshold and the target brightness is larger than or equal to the first preset dimming brightness threshold, the dimming mode of the display device is set to the transition dimming mode, wherein the transition dimming mode is executed between the PWM dimming mode and the DC dimming mode;
in the PWM dimming mode, a number of pulses of the light-emitting control signal controlled by the light-emitting control circuit in one frame of display screens is N1;
in the DC dimming mode, the number of pulses of the light-emitting control signal controlled by the light-emitting control circuit in one frame of display screens is N2; and
in the transition dimming mode, the number of pulses of the light-emitting control signal controlled by the light-emitting control circuit in one frame of display screens is N3, wherein N1, N2, and N3 are all positive integers, and N2<N3<N1.

2. The method according to claim 1, wherein:
when the PWM dimming mode is switched to the DC dimming mode, the transition dimming mode includes a plurality of first-transition dimming periods;
during an n-th first-transition dimming period of the plurality of first-transition dimming periods, the number of pulses of the light-emitting control signal controlled by the light-emitting control circuit in one frame of display screens is N3₍ₙ₎;
during an (n+1)-th first-transition dimming period of the plurality of first-transition dimming periods, the number of pulses of the light-emitting control signal controlled by the light-emitting control circuit in one frame of display screens is N3₍ₙ₊₁₎,
wherein:
n is a positive integer;
the (n+1)-th first-transition dimming period is executed after the n-th first-transition dimming period; and
$$N {3}_{( n + 1 )} < N {3}_{( n )} .$$

3. The method according to claim 2, wherein:
$$1 \leq N {3}_{( n )} - N {3}_{( n + 1 )} \leq 3 .$$

4. The method according to claim 2, wherein:
during an (n−1)-th first-transition dimming period of the plurality of first-transition dimming periods, the number of pulses of the light-emitting control signal controlled by the light-emitting control circuit in one frame of display screens is N3₍ₙ₋₁₎, wherein N3₍ₙ₎−N3₍ₙ₊₁₎=N3₍ₙ₋₁₎−N3₍ₙ₎.

5. The method according to claim 1, wherein:
when the DC dimming mode is switched to the PWM dimming mode, the transition dimming mode includes a plurality of second-transition dimming periods;
during an m-th second-transition dimming period of the plurality of second-transition dimming periods, the number of pulses of the light-emitting control signal controlled by the light-emitting control circuit in one frame of display screens is N3₍ₘ₎;
during an (m+1)-th second-transition dimming period of the plurality of second-transition dimming periods, the number of pulses of the light-emitting control signal controlled by the light-emitting control circuit in one frame of display screens is N3₍ₘ₊₁₎,
wherein:
m is a positive integer;
the (m+1)-th second-transition dimming period is executed after the n-th second-transition dimming period; and
$$N {3}_{( m + 1 )} > N {3}_{( m )} .$$

6. The method according to claim 5, wherein:
$$1 \leq N {3}_{( m + 1 )} - N {3}_{( m )} \leq 3 .$$

7. The method according to claim 5, wherein:
during an (m−1)-th second-transition dimming period of the plurality of second-transition dimming periods, the number of pulses of the light-emitting control signal controlled by the light-emitting control circuit in one frame of display screens is N3₍ₘ₋₁₎, wherein N3₍ₘ₊₁₎−N3₍ₘ₎=N3₍ₘ₎−N3₍ₘ₋₁₎.

8. The method according to claim 1, wherein:
$$N 2 = 1 or N 2 = 2 .$$

9. The method according to claim 2, further comprising:
obtaining a correspondence between actual brightness of the display device and a display brightness value of the display device, wherein: when the display brightness value increases from a first display brightness value to a second display brightness value, the transition dimming mode changes from the n-th first-transition dimming period to the (n+1)-th first-transition dimming period.

10. The method according to claim 5, further comprising:
obtaining a correspondence between actual brightness of the display device and a display brightness value of the display device, wherein: when the display brightness value decreases from a third display brightness value to a fourth display brightness value, the transition dimming mode changes from the m-th first-transition dimming period to the (m+1)-th first-transition dimming period.

11. The method according to claim 1, wherein:
the first preset dimming brightness threshold is larger than 0 nit, and the second preset dimming brightness threshold is less than or equal to 90 nit.

12. The method according to claim 1, wherein:
the display device includes a display area and a non-display area;
the display area includes a pixel circuit and a light-emitting element;
the pixel circuit includes a first power supply terminal, a second power supply terminal, a driving module, and the light-emitting module;
the driving module, the light-emitting module, and the light-emitting element are electrically connected between the first power supply terminal and the second power supply terminal;
the non-display area includes the light-emitting control circuit; and
an output end of the light-emitting control circuit is electrically connected to a control end of the light-emitting module.

13. The method according to claim 1, wherein:
the display device includes a driving chip, and the light-emitting control circuit is electrically connected to the driving chip;
the driving chip includes a storage module and a processor module;
a plurality of groups of relationship comparison tables are preset, each of which includes a corresponding relationship between a plurality of different display brightness values of the display device and different numbers of pulses of the light-emitting control signal controlled by the light-emitting control circuit within one frame of display screen in the transition dimming mode; and
the plurality of relationship comparison tables are stored in the storage module or the processor module.

14. The method according to claim 13, wherein:
one relationship comparison table includes a plurality of display brightness values including X1, X2, . . . , Xn; and
the relationship comparison table also includes a plurality of numbers of pulses of the light-emitting control signals including N3₍₁₎, N3₍₂₎, . . . , N3₍ₙ₎; wherein, X1 corresponds to N3₍₁₎, X2 corresponds to N3₍₂₎, . . . , and Xn corresponds to N3₍ₙ₎.

15. The method according to claim 13, wherein:
according to a visual effect of the display device, one group of relationship comparison tables is preferentially selected to execute the transition dimming mode.

16. The method according to claim 2, wherein:
the display device further includes a first automatic interpolation module;
the plurality of first-transition dimming periods include a first first-transition dimming period and a last first-transition dimming period;
during the first first-transition dimming period, the number of pulses of the light-emitting control signal controlled by the light-emitting control circuit in one frame of display screen is N3₍ₐ₎;
during the last first-transition dimming period, the number of pulses of the light-emitting control signal controlled by the light-emitting control circuit in one frame of display screen is N3_{(b)};
the first automatic interpolation module is used to automatically interpolate and obtain the number of pulses of the light-emitting control signal in one frame of display screens during others of the plurality of first-transition dimming periods according to N3₍ₐ₎ and N3_{(b)}.

17. The method according to claim 16, wherein:
based on a linear relationship diagram between display brightness values and the numbers of pulses of the light-emitting control signal, the first automatic interpolation module determines that the display brightness value of the display device is Xa and the number of pulses of the light-emitting control signal controlled by the light-emitting control circuit in one frame of display screen is N3₍ₐ₎ during the first first-transition dimming period; and determines that the display brightness value of the display device is Xb and the number of pulses of the light-emitting control signal controlled by the light-emitting control circuit in one frame of display screen is N3_{(b)} during the last first-transition dimming period, wherein the horizontal axis of the linear relationship diagram is the display brightness value and the vertical axis is the number of pulses of the light-emitting control signal; and
the first automatic interpolation module automatically interpolates and obtains, based on a first starting point determined by the horizontal coordinate Xa and the vertical coordinate N3₍ₐ₎, and a first ending point determined by the horizontal coordinate Xb and the vertical coordinate N3_{(b)} in the linear relationship diagram, the number of pulses of the light-emitting control signal controlled by the light-emitting control circuit in one frame of display screen corresponding to different display brightness values during other first-transition dimming periods of the plurality of first-transition dimming periods.

18. The method according to claim 5, wherein:
the display device further includes a second automatic interpolation module;
the plurality of second-transition dimming periods include a first second-transition dimming period and a last second-transition dimming period;
during the first second-transition dimming period, the number of pulses of the light-emitting control signal controlled by the light-emitting control circuit in one frame of display screens is N3_{(c)};
during the last second-transition dimming period, the number of pulses of the light-emitting control signal controlled by the light-emitting control circuit in one frame of display screens is N3_{(d)};
the second automatic interpolation module is used to automatically interpolate and obtain the number of pulses of the light-emitting control signal in one frame of display screen during others of the plurality of second-transition dimming periods according to N3_{(c)} and N3_{(d)}.

19. The method according to claim 18, wherein:
based on a linear relationship diagram between display brightness values and the numbers of pulses of the light-emitting control signal, the second automatic interpolation module determines that the display brightness value of the display device is Xc and the number of pulses of the light-emitting control signal controlled by the light-emitting control circuit in one frame of display screen is N3_{(c)} during the first second-transition dimming period; and determines that the display brightness value of the display device is Xd and the number of pulses of the light-emitting control signal controlled by the light-emitting control circuit in one frame of display screen is N3_{(d)} during the last second-transition dimming period, wherein the horizontal axis of the linear relationship diagram is the display brightness value and the vertical axis is the number of pulses of the light-emitting control signal; and
the second automatic interpolation module automatically interpolates and obtains, based on a second starting point determined by the horizontal coordinate Xc and the vertical coordinate N3_{(c)}, and a second ending point determined by the horizontal coordinate Xd and the vertical coordinate N3_{(d)} in the linear relationship diagram, the number of pulses of the light-emitting control signal controlled by the light-emitting control circuit in one frame of display screen corresponding to different display brightness values during other second-transition dimming periods of the plurality of second-transition dimming periods.

20. The method according to claim 1, wherein:
the light-emitting control circuit controls the light-emitting control signal to have the same pulse width within one frame of display screen.

21. A display device, comprising a light-emitting control circuit and a light-emitting module, wherein:
the light-emitting control circuit is electrically connected to the light-emitting module;
the light-emitting control circuit is used to provide a light-emitting control signal to the light-emitting module;
when a target brightness is less than a first preset dimming brightness threshold, a dimming mode of the display device is set to a PWM dimming mode; and
when the target brightness is larger than a second preset dimming brightness threshold, the dimming mode of the display device is set to a DC dimming mode, wherein the first preset dimming brightness threshold is less than the second preset dimming brightness threshold;
the display device further has a transition dimming mode;
when the target brightness is less than or equal to the second preset dimming brightness threshold and the target brightness is larger than or equal to the first preset dimming brightness threshold, the dimming mode of the display device is set to the transition dimming mode, wherein the transition dimming mode is executed between the PWM dimming mode and the DC dimming mode;
in the PWM dimming mode, a number of pulses of the light-emitting control signal controlled by the light-emitting control circuit in one frame of display screens is N1;
in the DC dimming mode, the number of pulses of the light-emitting control signal controlled by the light-emitting control circuit in one frame of display screens is N2; and
in the transition dimming mode, the number of pulses of the light-emitting control signal controlled by the light-emitting control circuit in one frame of display screens is N3, wherein N1, N2, and N3 are all positive integers, and N2<N3<N1.
